(19) United States
(12) Patent Application Publication
(10) Pub. No.: US 2025/0247867 A1
(43) Pub. Date: Jul. 31, 2025

(54) METHOD AND APPARATUS FOR CONFIGURING AND TRANSMITTING SYNCHRONIZATION SIGNAL FOR BEAM TRACKING AND MANAGEMENT IN SIDELINK COMMUNICATION

(71) Applicants: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(72) Inventors: Ui Hyun HONG, Hwaseong-si, Gyeonggi-do (KR); Hyuk Min SON, Seoul (KR)

(73) Assignees: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(21) Appl. No.: 19/101,803

(22) PCT Filed: Oct. 6, 2023
(86) PCT No.: PCT/KR2023/015378

§ 371 Date: Feb. 6, 2025

(30) Foreign Application Priority Data
Oct. 6, 2022 (KR) 10-2022-0127913

(51) Int. Cl. H04W 72/25; H04B 7/06; H04W 72/0446; H04W 72/0453

(52) U.S. Cl. CPC H04W 72/25; H04B 7/06952; H04W 72/0446; H04W 72/0453

(57) ABSTRACT

Disclosed are a method and apparatus for configuring and transmitting a synchronization signal for beam tracking and management in sidelink communication. The method for a first UE comprises the steps of: transmitting one or more BM-S-SSBs to a second UE; and on the basis of the one or more BM-S-SSBs, receiving a measured BSI from the second UE, wherein each of the one or more BM-S-SSBs includes an S-PSS and an S-SSS without a PSBCH.

### TECHNICAL FIELD

The present disclosure relates to a sidelink communication technique, and more particularly, to a technique for configuring and transmitting synchronization signals for beam tracking and management.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New

Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, beam tracking and/or beam management operations for sidelink communication may be required. The beam tracking/management operations can be performed based on channel state information-reference signals (CSI-RS). Additionally, beam tracking/management operations using sidelink-synchronization signal blocks (S-SSB) may be considered. In this case, S-SSB configuration and transmission methods for beam tracking/management operations may be required.

### DISCLOSURE

### Technical Problem

The present disclosure is directed to providing a method and an apparatus for configuring and transmitting synchronization signals for beam tracking/management in sidelink communication.

### Technical Solution

A method of a first user equipment (UE), according to exemplary embodiments of the present disclosure for achieving the above-described objective, may comprise: transmitting one or more beam management (BM)-sidelink (S)-synchronization signal blocks (SSBs) to a second UE; and receiving beam state information (BSI) measured based on the one or more BM-S-SSBs from the second UE, wherein each of the one or more BM-S-SSBs includes a sidelink-primary synchronization signal (S-PSS) and a sidelink-secondary synchronization signal (S-SSS) without a physical sidelink broadcast channel (PSBCH).

The method may further comprise: transmitting one or more Sync-S-SSBs to the second UE before transmitting the one or more BM-S-SSBs, wherein the one or more Sync-S-SSBs are used for synchronization between the first UE and the second UE, and each of the one or more Sync-S-SSBs includes an S-PSS, S-SSS, and PSBCH.

Each of the one or more BM-S-SSBs may further include a BM reference signal (RS), and the BM RS may be mapped to a transmission resource of the PSBCH in time domain.

The BM RS may be mapped to one or more subcarriers that do not overlap with a PSBCH demodulation reference signal (DMRS) included in a Sync-S-SSB transmitted by the first UE in frequency domain.

The one or more subcarriers to which the BM RS is mapped in frequency domain may be determined based on an offset with respect to subcarriers to which the PSBCH DMRS is mapped.

The BM-S-SSB may further include at least one of one or more additional S-PSSs or one or more additional S-SSSs, and the at least one of the one or more additional S-PSSs or the one or more additional S-SSSs may be mapped to a transmission resource of the PSBCH in time domain.

The method may further comprise: receiving synchronization configuration information including first configuration information of Sync-S-SSB and second configuration information of BM-S-SSB from a base station, wherein the one or more Sync-S-SSBs may be transmitted based on the first configuration information, and the one or more BM-S-SSBs may be transmitted based on the second configuration information.

The one or more Sync-S-SSBs and the one or more BM-S-SSBs may be independently configured, and transmission resources of the one or more Sync-S-SSBs may be different from transmission resources of the one or more BM-S-SSBs.

The method may further comprise: maintaining or changing beam(s) used in SL communication between the first UE and the second UE based on the BSI.

The one or more BM-S-SSBs may be transmitted based on a beam sweeping scheme according to a beam pattern, and the one or more BM-S-SSBs may be transmitted through different beams in units of n BM-S-SSBs, n being a natural number.

A method of a second user equipment (UE), according to exemplary embodiments of the present disclosure for achieving the above-described objective, may comprise: receiving one or more beam management (BM)-sidelink (S)-synchronization signal block (SSBs) from a first UE; measuring beam information for the first UE based on the one or more BM-S-SSBs; and transmitting beam state information (BSI) including the beam information to the first UE, wherein each of the one or more BM-S-SSBs includes a sidelink-primary synchronization signal (S-PSS) and a sidelink-secondary synchronization signal (S-SSS) without a physical sidelink broadcast channel (PSBCH).

The method may further comprise: before receiving the one or more BM-S-SSBs, receiving one or more Sync-S-SSBs from the first UE; and obtaining synchronization information of the first UE based on the one or more Sync-S-SSBs, wherein each of the one or more Sync-S-SSBs includes an S-PSS, S-SSS, and PSBCH.

Each of the one or more BM-S-SSBs may further include a BM reference signal (RS), and the BM RS may be mapped to a transmission resource of the PSBCH in time domain.

The BM RS may be mapped to one or more subcarriers that do not overlap with a PSBCH demodulation reference signal (DMRS) included in a Sync-S-SSB received from the first UE in frequency domain.

The BM-S-SSB may further include at least one of one or more additional S-PSSs or one or more additional S-SSSs, and the at least one of the one or more additional S-PSSs or the one or more additional S-SSSs may be mapped to a transmission resource of the PSBCH in time domain.

A first user equipment (UE), according to exemplary embodiments of the present disclosure for achieving the above-described objective, may comprise at least one processor, wherein the at least one processor may cause the first UE to perform: transmitting one or more beam management (BM)-sidelink (S)-synchronization signal blocks (SSBs) to a second UE; and receiving beam state information (BSI) measured based on the one or more BM-S-SSBs from the second UE, wherein each of the one or more BM-S-SSBs includes a sidelink-primary synchronization signal (S-PSS) and a sidelink-secondary synchronization signal (S-SSS) without a physical sidelink broadcast channel (PSBCH).

The at least one processor may further cause the first UE to perform: transmitting one or more Sync-S-SSBs to the second UE before transmitting the one or more BM-S-SSBs, wherein the one or more Sync-S-SSBs may be used for synchronization between the first UE and the second UE, and each of the one or more Sync-S-SSBs includes an S-PSS, S-SSS, and PSBCH.

Each of the one or more BM-S-SSBs may further include a BM reference signal (RS), and the BM RS may be mapped to a transmission resource of the PSBCH in time domain.

The BM RS may be mapped to one or more subcarriers that do not overlap with a PSBCH demodulation reference signal (DMRS) included in a Sync-S-SSB transmitted by the first UE in frequency domain.

The BM-S-SSB may further include at least one of one or more additional S-PSSs or one or more additional S-SSSs, and the at least one of the one or more additional S-PSSs or the one or more additional S-SSSs may be mapped to a transmission resource of the PSBCH in time domain.

### Advantageous Effects

According to the present disclosure, a transmitting terminal can transmit a Sync-sidelink (S)-synchronization signal block (SSB) and a beam management (BM)-S-SSB to a receiving terminal. The Sync-S-SSB can be used for synchronization between the transmitting terminal and the receiving terminal, and the BM-S-SSB can be used for beam management operations between the transmitting terminal and the receiving terminal. The receiving terminal can measure beam information of the transmitting terminal based on the BM-S-SSB and transmit measurement results of the beam information to the transmitting terminal. The transmitting terminal can receive the measurement results of the beam information from the receiving terminal and maintain or change transmitting beam(s) of the transmitting terminal based on the measurement results of the beam information. According to the above-described operation, the beam management operations in SL communication can be appropriately performed, and the performance of SL communication can be improved.

### Description of Drawings

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a conceptual diagram illustrating a first exemplary embodiment of an S-SSB.

FIG. 10 is a conceptual diagram illustrating a first exemplary embodiment of an S-SSB period.

FIG. 11 is a conceptual diagram illustrating a first exemplary embodiment of a structure of a synchronization signal.

FIG. 12 is a conceptual diagram illustrating a second exemplary embodiment of a structure of a synchronization signal.

FIG. 13 is a conceptual diagram illustrating a third exemplary embodiment of a structure of a synchronization signal.

FIG. 14 is a conceptual diagram illustrating a fourth exemplary embodiment of a structure of a synchronization signal.

FIG. 15 is a conceptual diagram illustrating a fifth exemplary embodiment of a structure of a synchronization signal.

FIG. 16 is a conceptual diagram illustrating a sixth exemplary embodiment of a structure of a synchronization signal.

FIG. 17 is a conceptual diagram illustrating a first exemplary embodiment of a method for transmitting synchronization signals.

FIG. 18 is a conceptual diagram illustrating a second exemplary embodiment of a method for transmitting synchronization signals.

FIG. 19 is a conceptual diagram illustrating a third exemplary embodiment of a method for transmitting synchronization signals.

FIG. 20 is a conceptual diagram illustrating a fourth exemplary embodiment of a method for transmitting synchronization signals.

FIG. 21 is a conceptual diagram illustrating a fifth exemplary embodiment of a method for transmitting synchronization signals.

FIG. 22 is a conceptual diagram illustrating a sixth exemplary embodiment of a method for transmitting synchronization signals.

FIG. 23 is a conceptual diagram illustrating a seventh exemplary embodiment of a method for transmitting synchronization signals.

FIG. 24 is a conceptual diagram illustrating an eighth exemplary embodiment of a method for transmitting synchronization signals.

FIG. 25 is a sequence chart illustrating a first exemplary embodiment of a beam management method.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

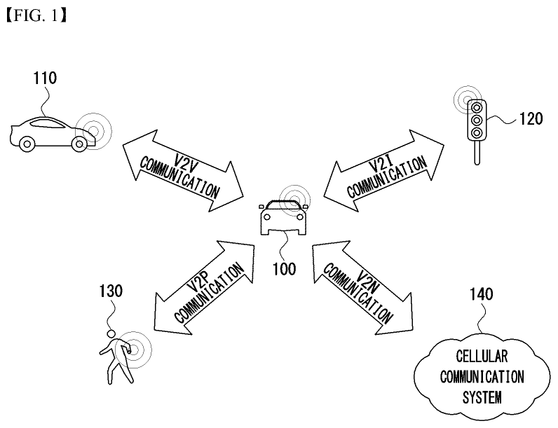

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

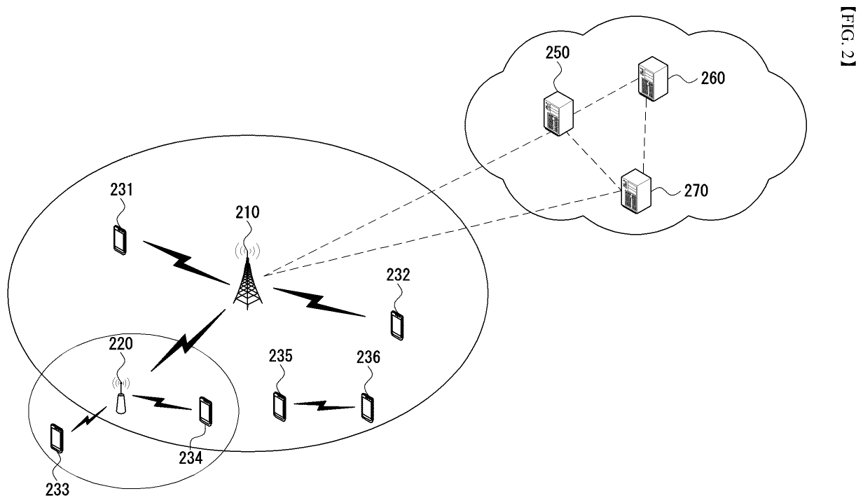

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

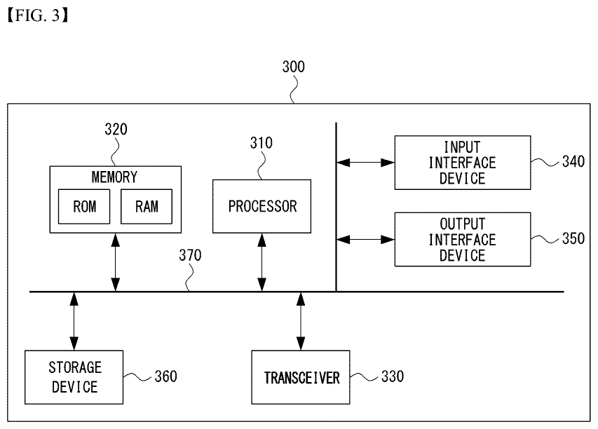

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

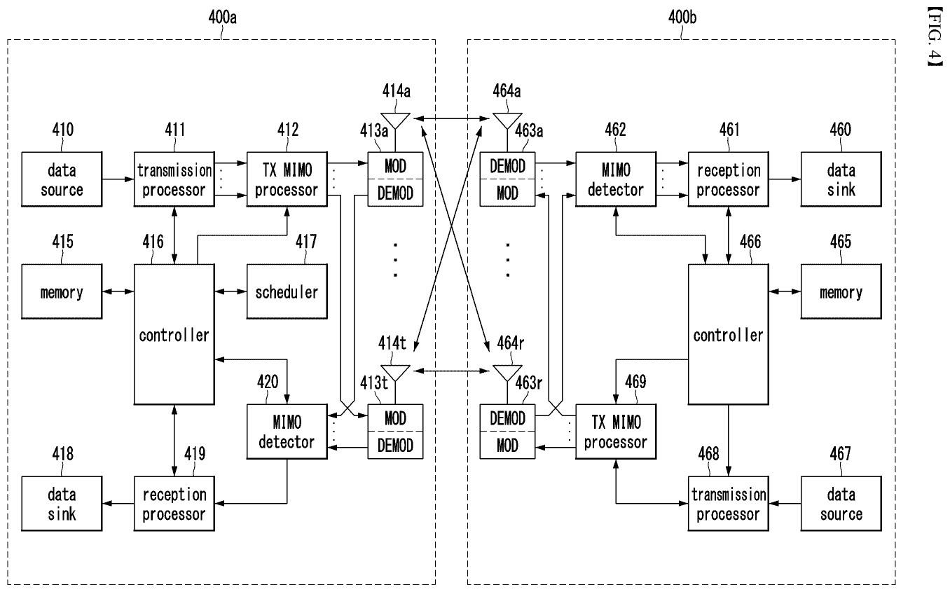

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

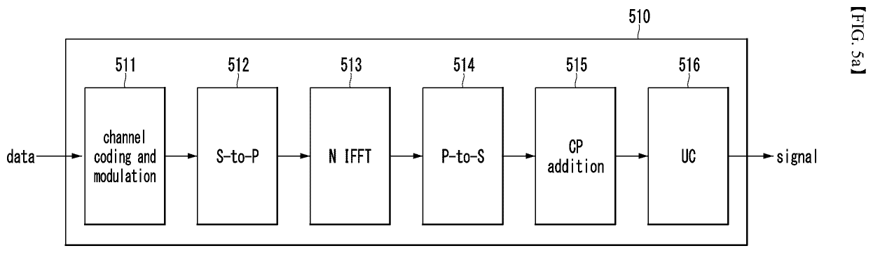

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of base | Out of coverage of base |
| | station 210 | station 210 |
| B | In coverage of base | Out of coverage of base |
| | station 210 | station 210 |
| C | In coverage of base | In coverage of base |
| | station 210 | station 210 |
| D | In coverage of base | In coverage of other base |
| | station 210 | station |

Meanwhile, a user plane protocol stack of the UEs (e.g., the UEs 235 and 236) performing sidelink communications may be configured as follows.

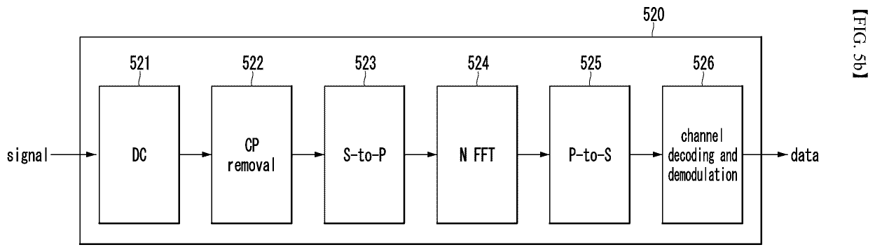

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

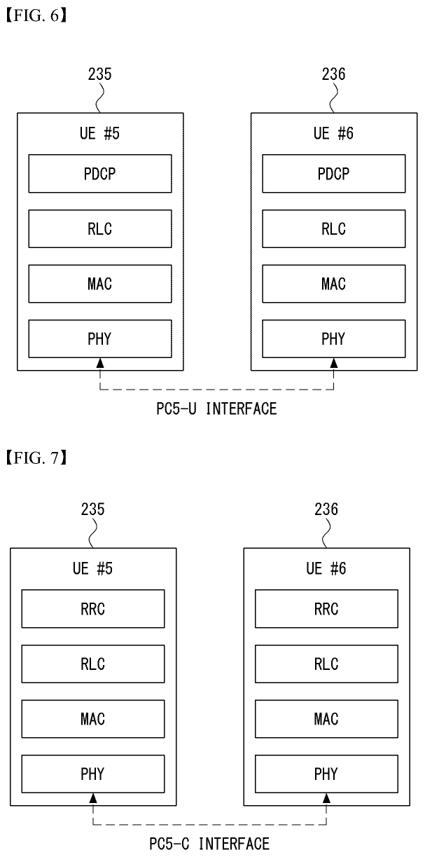

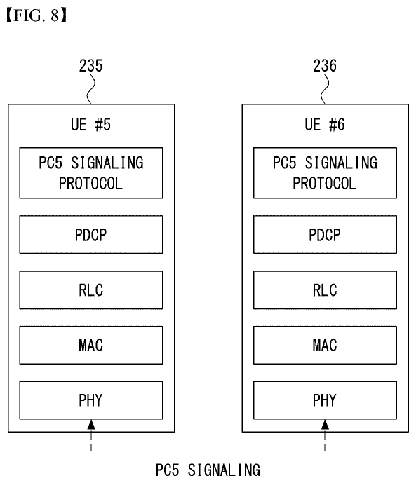

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources scheduled by base station |
| 2 | UE autonomous transmission without scheduling of base |
| | station |
| 3 | Transmission using resources scheduled by base station in |
| | V2X communications |
| 4 | UE autonomous transmission without scheduling of base |
| | station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH.

The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink (SL) communication may support beam management operations. The beam management operations may be supported in an FR2 band. In the present disclosure, the beam management operations may refer to operations that include beam tracking operations. The beam management operations may be performed based on at least one of aperiodic channel state information (CSI) reporting, periodic CSI reporting, or semi-persistent CSI reporting. SCI (e.g., SCI format 2-A and/or 2-C) may include a CSI request field, and the beam management operations may be performed based on an aperiodic CSI report triggered by the SCI.

A first terminal may transmit a CSI-RS (e.g., CSI-RS for beam management) in each of symbols belonging to an SL slot. The first terminal may transmit the CSI-RS based on a beam sweeping operation. In other words, the first terminal may transmit the CSI-RS using different beams (e.g., different transmission beams) in the respective symbols belonging to the SL slot. A second terminal may receive the CSI-RS from the first terminal. A reception operation for the CSI-RS may be performed based on a beam sweeping operation. For example, the second terminal may perform the reception operation for the CSI-RS using different beams (e.g., different reception beams). If the transmission and reception operations of the CSI-RS (e.g., reference signal) are performed based on the beam sweeping operations, resources for CSI-RS transmission and reception may be insufficient.

When resources for beam sweeping operations of the reference signals are allocated, symbols for SL data transmission (e.g., PSSCH symbols) may be insufficient. Therefore, beam management operations based on signals (e.g., synchronization signals) other than reference signals may be required in SL communication.

Beam management operations in an NR Uu link may be defined as follows.
Signals used for CSI measurement: a CSI-RS set and/or synchronization signal blocks (SSBs)
channel quality indicator (CQI) metric for beams: L1-reference signal received power (RSRP)
Maximum number of CSIs that can be reported for each terminal: 4 (e.g., CSI reporting for 4 beams is possible)
Reported information: The largest L1-RSRP among L1-RSRPs of beams and/or differences between the largest L1-RSRP and L1-RSRPs of the remaining beams
CSI-RS transmission type: CSI reporting type+channel used for CSI reporting
   Periodic type: periodic CSI reporting+physical uplink control channel (PUCCH)
   Semi-persistent type: periodic CSI reporting+PUCCH or semi-persistent CSI reporting+physical uplink shared channel (PUSCH)
   Aperiodic type: aperiodic CSI reporting (e.g., aperiodic CSI reporting triggered by DCI with a CSI request field)+PUSCH
Beam adjustment for each of downlink transmission and reception beams may be performed. If beam reciprocity is established between uplink and downlink, beam management operations (e.g., beam adjustment operations) may only be performed for downlink.

CSI-related operations in an NR SL link may be defined as follows.
Signals used for CSI measurement: CSI-RS set
CQI metric: L1-RSRP
Maximum CSI-RS ports: 2
CSI-RS transmission type: CSI reporting type+channel used for CSI reporting
   Aperiodic type: aperiodic CSI reporting (e.g., aperiodic CSI reporting triggered by SCI format 2-A or 2-C with a CSI request field)+PSSCH (e.g., MAC CE)

Sidelink-synchronization signal block (S-SSB)-related operations in NR communication may be defined as follows.
Unlike SSB transmission in the NR Uu link, S-SSB transmission in the NR SL link may be performed at a fixed periodicity. The fixed periodicity may be 160 ms.
As shown in Table 3 below, transmission of multiple S-SSBs within one S-SSB period may be possible depending on a frequency range (FR) and/or subcarrier spacing (SCS).

TABLE 3

| FR | SCS | Number of S-SSBs within an S-SSB period |
|---|---|---|
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

In SL communication, S-SSBs may be used for beam management (e.g., beam quality measurement) for beams (e.g., transmission beams and/or reception beams) between a transmitting terminal and a receiving terminal. In other words, beam management operations may be performed using S-SSBs.

In the present disclosure, a terminal transmitting S-SSBs for beam information measurement may be referred to as a transmitting terminal (or a first terminal), and a terminal receiving the S-SSBs may be referred to as a receiving terminal (or a second terminal). The receiving terminal may obtain (e.g., measure) beam information based on the S-SSBs and may report the beam information to the transmitting terminal when necessary. The beam information may be information on transmission beam(s) of the transmitting terminal and/or information on reception beam(s) of the receiving terminal. The beam information measured by the receiving terminal may be defined as beam state information (BSI). For example, the BSI may include an index of a specific beam, beam quality information (e.g., RSRP, reference signal received quality (RSRQ), received signal strength indicator (RSSI), etc.), and/or calculation results for beam quality measured values (e.g., RSRP, RSRQ, RSSI, etc.).

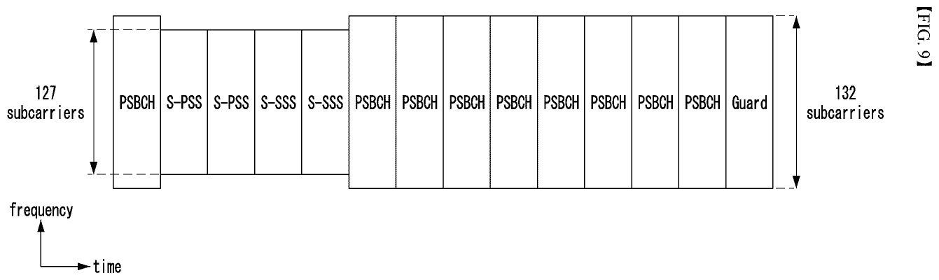

FIG. 9 is a conceptual diagram illustrating a first exemplary embodiment of an S-SSB.

As shown in FIG. 9, an S-SSB may include a sidelink-primary synchronization signal (S-PSS), a sidelink-secondary synchronization signal (S-SSS), and a PSBCH. The S-SSB may further include a PSBCH DMRS. The PSBCH DMRS may be a DMRS used for demodulation of the PSBCH. The S-SSB may be transmitted within a single slot. In the S-SSB illustrated in FIG. 9, a normal cyclic prefix (CP) may be applied. In the present disclosure, the S-SSB illustrated in FIG. 9, a variant S-SSB from the S-SSB illustrated in FIG. 9, an extended S-SSB from the S-SSB illustrated in FIG. 9, and/or a combined S-SSB from the S-SSB illustrated in FIG. 9 may be used.

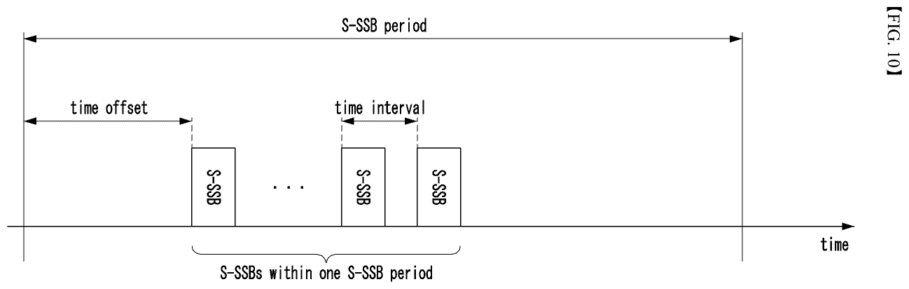

FIG. 10 is a conceptual diagram illustrating a first exemplary embodiment of an S-SSB period.

As shown in FIG. 10, one or more S-SSBs may be transmitted within an S-SSB period. A periodicity of the S-SSB period may be 160 ms. The periodicity of the S-SSB period may be a fixed periodicity. A time offset from a start time of the S-SSB period to a transmission time of the first S-SSB and/or a time interval between the S-SSBs may be configured to terminal(s) through signaling. A terminal may transmit S-SSB(s) in various manners based on the time offset and/or the time interval. In the present disclosure, the S-SSB period illustrated in FIG. 10, a variant S-SSB period from the S-SSB period illustrated in FIG. 10, an extended S-SSB period from the S-SSB period illustrated in FIG. 10, and/or a combined S-SSB period from the S-SSB period illustrated in FIG. 10 may be used.

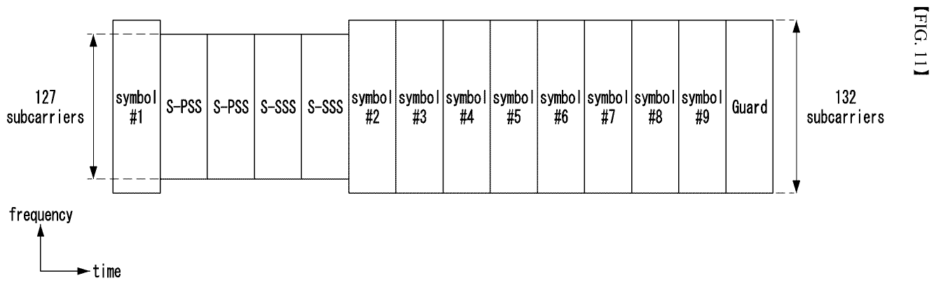

FIG. 11 is a conceptual diagram illustrating a first exemplary embodiment of a structure of a synchronization signal.

As shown in FIG. 11, resources (e.g., resource section, resource region) used for PSBCH transmission may be symbols #1 to #9. Nine symbols (e.g., symbols #1 to #9) within a slot (e.g., a slot in which a synchronization signal is transmitted) may be used for beam management operations. For example, the symbols #1 to #9 may be used for purposes other than PSBCH transmission (e.g., purposes related to beam management operations).

In the present disclosure, S-SSBs may be classified into beam management (BM)-S-SSB and Sync-S-SSB. The BM-S-SSB may refer to an S-SSB used for beam management operations (e.g., beam measurement operations). In a slot where the BM-S-SSB is transmitted and/or arranged, specific resources (e.g., symbols #1 to #9) may be used for purposes other than PSBCH transmission (e.g., purposes related to beam management operations). The BM-S-SSB may include an S-PSS and S-SSS without a PSBCH. The Sync-S-SSB may refer to an S-SSB used for synchronization. The Sync-S-SSB may correspond to the S-SSB illustrated in FIG. 9. The Sync-S-SSB may include an S-PSS, S-SSS, and PSBCH. Additionally, the Sync-S-SSB may further include a PSBCH DMRS. Transmission resources of BM-S-SSBs may be configured differently from transmission resources of Sync-S-SSBs. The transmission resources may include time resources, frequency resources, spatial resources, and/or transmission periodicity. Alternatively, the transmission resources of BM-S-SSBs may be configured the same as the transmission resources of Sync-S-SSBs.

To distinguish the S-SSBs (e.g., BM-S-SSB and/or Sync-S-SSB), SLSS identifiers (IDs) may be used. A transmitting terminal may transmit full or partial information of an SLSS ID to a receiving terminal through signaling (e.g., RRC signaling, MAC signaling, and/or PHY signaling). The receiving terminal may identify S-SSB(s) transmitted by the transmitting terminal based on the information (e.g., SLSS ID) received from the transmitting terminal.

The present disclosure will describe BM-S-SSB structures. Configuration information of BM-S-SSB (hereinafter referred to as ‘synchronization configuration information’) may be signaled to terminal(s). The synchronization configuration information may include configuration information of BM-S-SSB and/or configuration information of Sync-S-SSB. The synchronization configuration information may include at least one of transmission resource information, identifier information (e.g., SLSS ID), beam pattern information, structure information, or type information of a synchronization signal (e.g., BM-S-SSB). The transmission resource information may include at least one of time resource information, frequency resource information, spatial resource information, or transmission periodicity information of BM-S-SSB. The beam pattern information may indicate transmission beam(s) of the transmitting terminal used for BM-S-SSB transmission. The structure information may indicate a structure of BM-S-SSB (e.g., types of signals included in BM-S-SSB). The type information may indicate whether the synchronization signal transmitted by the transmitting terminal is BM-S-SSB or Sync-S-SSB. In the disclosure, the synchronization signal may refer to BM-S-SSB and/or Sync-S-SSB.

The base station may signal the synchronization configuration information to terminals. Alternatively, the transmitting terminal may signal the synchronization configuration information to receiving terminal(s). The signaling may include at least one of system information (SI) signaling, RRC signaling, MAC signaling, or PHY signaling. Terminals (e.g., transmitting terminal and/or receiving terminal) may receive the synchronization configuration information through signaling. The transmitting terminal may transmit synchronization signals (e.g., BM-S-SSB and/or Sync-S-SSB) to receiving terminal(s) based on the synchronization configuration information. The transmitting terminal may provide synchronization information to the receiving terminals performing beam management operations by transmitting BM-S-SSB. The receiving terminals may perform reception operations for BM-S-SSB based on the synchronization configuration information and may perform synchronization configuration and/or beam management based on BM-S-SSB.

The receiving terminal may receive the synchronization signal (e.g., BM-S-SSB and/or Sync-S-SSB) and may identify the transmitting terminal that transmitted the synchronization signal. For example, in cases where the receiving terminal performs SL communication with one or more transmitting terminals or the receiving terminal performs beam management operations with one or more transmitting terminals, the receiving terminal may receive synchronization signal(s) from one or more transmitting terminals and may identify the transmitting terminal that transmitted the synchronization signal received by the receiving terminal. The synchronization signal may be configured to be transmitted through a beam between the transmitting terminal and the receiving terminal. In this case, the receiving terminal may periodically measure a state of the beam based on the synchronization signal received from the transmitting terminal.

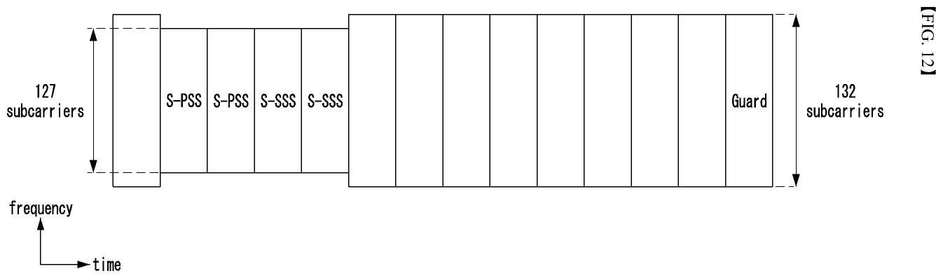

FIG. 12 is a conceptual diagram illustrating a second exemplary embodiment of a structure of a synchronization signal.

As shown in FIG. 12, a BM-S-SSB may include an S-PSS and S-SSS. The BM-S-SSB may not include a PSBCH and a PSBCH DMRS. In other words, no signal may be transmitted in PSBCH transmission resources (e.g., symbols #1 to #9 shown in FIG. 11). When the BM-S-SSB (e.g., BM-S-SSB that does not include a PSBCH) and Sync-S-SSB are transmitted in the same resources, the BM-S-SSB may not cause interference with a PSBCH included in the Sync-S-SSB. In this case, an initial access terminal and/or a re-access terminal may easily acquire synchronization information.

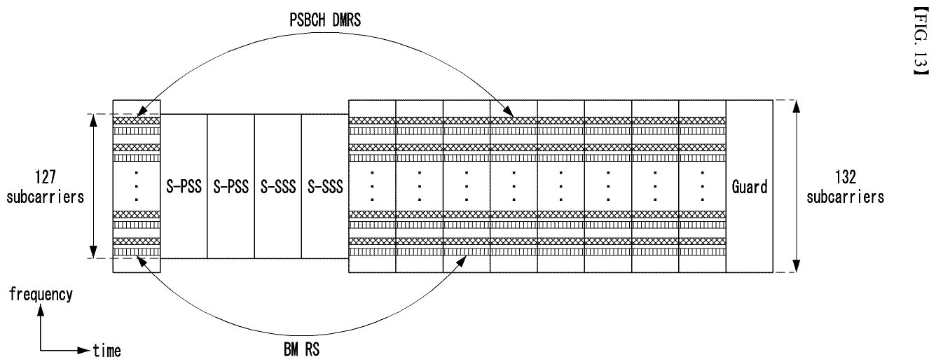

FIG. 13 is a conceptual diagram illustrating a third exemplary embodiment of a structure of a synchronization signal.

As shown in FIG. 13, a BM-S-SSB may include an S-PSS, S-SSS, and beam management (BM) reference signal (RS). The BM RS may be used for beam management operations (e.g., measurement operations for beam information). The existing RS may be reused as the BM RS. For example, the BM RS may be a CSI-RS. Alternatively, the BM RS may be a newly defined RS specifically used for beam management. The BM-S-SSB may not include a PSBCH and a PSBCH DMRS. In the time domain, the BM RS may be arranged in (e.g., mapped to) PSBCH transmission resources (e.g., symbols #1 to #9 shown in FIG. 11). The BM RS may be mapped to some of the PSBCH symbols. The PSBCH symbols may refer to symbols where a PSBCH is transmitted (e.g., mapped). In the frequency domain, the BM RS may be mapped to one or more subcarriers among frequency resources (e.g., frequency region) of a PSBCH, excluding subcarriers to which a PSBCH DMRS is mapped. In other words, in the frequency domain, the BM RS may be mapped to one or more subcarriers that do not overlap with the PSBCH DMRS. In this case, interference caused by the BM-S-SSB to a PSBCH DMRS of Sync-S-SSB may be minimized, and the number of symbols used for measuring beam information (e.g., information on transmission beams of the transmitting terminal and/or information on reception beams of the receiving terminal) in beam management operations based on BM-S-SSB may be maximized.

In the frequency domain, the BM RS may be configured relative to the PSBCH DMRS. A gap between a position of the BM RS and a position of the PSBCH DMRS in the frequency domain may be expressed as an offset. If the offset is set to +X, the BM RS may be mapped to subcarrier(s) X subcarriers above subcarriers to which the PSBCH DMRS is mapped in the frequency domain. If the offset is set to −X, the BM RS may be mapped to subcarrier(s) X subcarriers below the subcarriers to which the PSBCH DMRS is mapped in the frequency domain. The offset (X) may be signaled to terminal(s). For example, the synchronization configuration information may include the offset X. X may be a natural number.

The transmitting terminal may transmit the BM-S-SSB based on the synchronization configuration information. The BM RS included in the BM-S-SSB may be transmitted on subcarrier(s) determined based on the offset X. The receiving terminal may perform a reception operation for the BM-S-SSB based on the synchronization configuration information. The receiving terminal may identify the subcarrier(s) in which the BM RS included in the BM-S-SSB is transmitted based on the offset X and may receive the BM RS in the identified subcarrier(s). The receiving terminal may measure beam information based on the BM RS.

Alternatively, an index of the lowest subcarrier (or the highest subcarrier) in a frequency region where the BM-S-SSB is transmitted and a subcarrier offset may be configured to terminal(s). The BM RS may be mapped to subcarrier(s) corresponding to the subcarrier offset from the lowest subcarrier (or the highest subcarrier) in the frequency region of the BM-S-SSB. The BM RS may be mapped in the frequency domain according to a spacing of the subcarrier offset. The transmitting terminal and/or receiving terminal may identify the subcarrier(s) to which the BM RS is mapped based on the index of the lowest subcarrier (or the highest subcarrier) and the subcarrier offset. The transmitting terminal may transmit the BM RS in the identified subcarrier(s), and the receiving terminal may receive the BM RS in the identified subcarrier(s).

The BM RS may be configured based on various schemes. Configuration information of BM RS may be included in the synchronization configuration information. The configuration information of BM RS may include at least one of information indicating time resource(s) to which the BM RS is mapped, information indicating frequency resource(s) to which the BM RS is mapped (e.g., the lowest subcarrier index, the highest subcarrier index, and/or the subcarrier offset), a transmission pattern of the BM RS, or a transmission density of the BM RS. The configuration information of BM RS may be transmitted based on at least one of RRC signaling, MAC signaling, or PHY signaling. The BM RS may be configured in a resource pool-specific, sidelink-specific, and/or UE-specific manner.

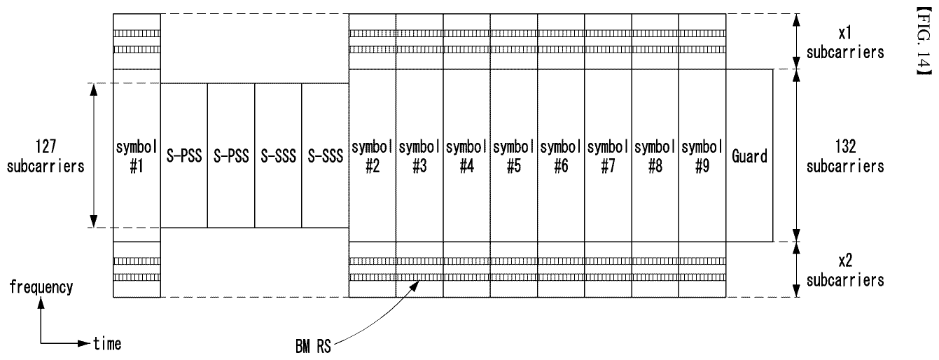

FIG. 14 is a conceptual diagram illustrating a fourth exemplary embodiment of a structure of a synchronization signal.

As shown in FIG. 14, a BM-S-SSB may include an S-PSS, S-SSS, and BM RS. The BM RS may be used for beam management operations (e.g., measurement operations for beam information). The existing RS may be reused as the BM RS. For example, the BM RS may be a CSI-RS. Alternatively, the BM RS may be a newly defined RS used specifically for beam management. The BM-S-SSB may not include a PSBCH and PSBCH DMRS. In the time domain, time resource(s) to which the BM RS is mapped may be time resource(s) to which a PSBCH included in Sync-S-SSB is mapped. The BM RS may be mapped to some of PSBCH symbols. In the frequency domain, frequency resource(s) to which the BM RS is mapped may be frequency resource(s) outside frequency resources to which the Sync-S-SSB (e.g., PSBCH) is mapped.

For example, the BM RS may be mapped to at least one subcarrier among x1 subcarriers and x2 subcarriers. The x1 subcarriers and x2 subcarriers may be subcarriers outside the frequency resources to which the Sync-S-SSB (e.g., PSBCH) is mapped. Each of x1 and x2 may be a natural number. Additional frequency resource(s) (e.g., additional subcarrier(s)) may be allocated for the BM RS. A frequency region where the BM-S-SSB is transmitted may be wider than a frequency region where the Sync-S-SSB is transmitted. Interference caused by the BM-S-SSB to the PSBCH of the Sync-S-SSB may be minimized, and the number of symbols used for beam information measurement in beam management operations based on the BM-S-SSB may be maximized.

The index of the lowest subcarrier (or the highest subcarrier) in the frequency region where the BM-S-SSB is transmitted and the subcarrier offset may be configured to terminals. The BM RS may be mapped to subcarrier(s) corresponding to the subcarrier offset from the lowest subcarrier (or the highest subcarrier) in the frequency region of BM-S-SSB. The BM RS may be mapped in the frequency domain according to a spacing of the subcarrier offset. The transmitting terminal and/or receiving terminal may identify the subcarrier(s) to which the BM RS is mapped based on the index of the lowest subcarrier (or the highest subcarrier) and the subcarrier offset. The transmitting terminal may transmit the BM RS in the identified subcarrier(s), and the receiving terminal may receive the BM RS in the identified subcarrier(s).

The BM RS may be configured based on various schemes. Configuration information of BM RS may be included in the synchronization configuration information. The configuration information of BM RS may include at least one of information indicating time resource(s) to which the BM RS is mapped, information indicating frequency resource(s) to which the BM RS is mapped (e.g., the lowest subcarrier index, the highest subcarrier index, and/or the subcarrier offset), a transmission pattern of the BM RS, or a transmission density of the BM RS. Frequency resource(s) for transmission of the BM-RS may be additionally configured. The configuration information of BM RS may be transmitted based on at least one of RRC signaling, MAC signaling, or PHY signaling. The BM RS may be configured in a resource pool-specific, sidelink-specific, and/or UE-specific manner.

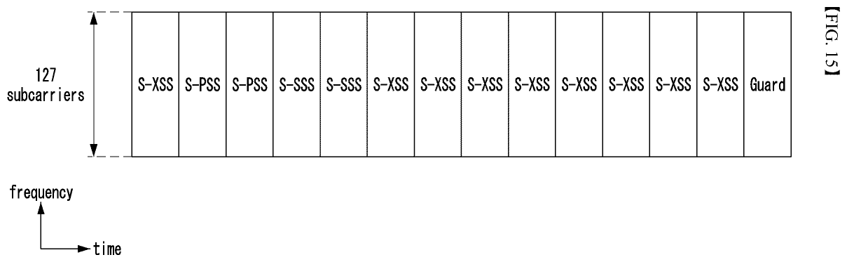

FIG. 15 is a conceptual diagram illustrating a fifth exemplary embodiment of a structure of a synchronization signal.

As shown in FIG. 15, a BM-S-SSB may include an S-PSS, S-SSS, and S-XSS. The BM-S-SSB may not include reference signals (e.g., BM RS). The S-XSS may be an S-PSS (e.g., additional S-PSS) or S-SSS (e.g., additional S-SSS). In other words, the S-PSS and/or S-SSS may be additionally transmitted. The S-PSS and/or S-SSS may be signals known to terminal(s). The S-XSS may be arranged in (e.g., mapped to) PSBCH transmission resources (e.g., symbols #1 to #9 shown in FIG. 11). Configuration information of BM-S-SSB (e.g., synchronization configuration information) may be signaled to terminal(s).

The transmitting terminal may transmit the BM-S-SSB to the receiving terminal. The receiving terminal may receive the BM-S-SSB and measure beam information (e.g., information of transmission beam(s) of the transmitting terminal and/or information of reception beam(s) of the receiving terminal) based on the BM-S-SSB. Since the S-SSS, S-PSS, and S-XSS of BM-S-SSB are mapped to all symbols within a slot (e.g., excluding an automatic gain control (AGC) symbol and/or guard symbol), the receiving terminal may perform beam information measurement operations in all symbols within the slot (e.g., excluding the AGC symbol and/or guard symbol).

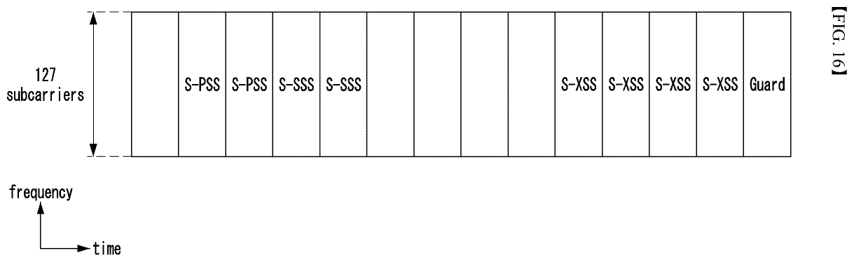

FIG. 16 is a conceptual diagram illustrating a sixth exemplary embodiment of a structure of a synchronization signal.

As shown in FIG. 16, a BM-S-SSB may include an S-PSS, S-SSS, and S-XSS. The BM-S-SSB may not include reference signals (e.g., BM RS). The S-XSS may be an S-PSS (e.g., additional S-PSS) or S-SSS (e.g., additional S-SSS). In other words, the S-PSS and/or S-SSS may be additionally transmitted. The S-PSS and/or S-SSS may be signals known to terminal(s). The BM-S-SSB may be transmitted not only in the existing symbols where the S-SSS/S-PSS is transmitted but also in additional symbol(s). In this case, the receiving terminal may perform beam information measurement operations in both the existing symbols and the additional symbol(s).

To minimize interference caused by the BM-S-SSB to Sync-S-SSB (e.g., PSBCH included in the Sync-S-SSB), the S-XSS may be mapped to some symbols among PSBCH transmission resources. The S-XSS may be mapped to five symbols among all the PSBCH symbols (e.g., 9 PSBCH symbols), and the S-XSS may not be mapped to the remaining 4 PSBCH symbols. In this case, interference caused by the S-XSS of the BM-S-SSB to the PSBCH of Sync-S-SSB may be reduced.

In the exemplary embodiment(s), the symbol #1 (e.g., the first symbol in the slot) may be used for AGC operations. Accordingly, a sequence or signal known to the transmitting terminal and the receiving terminal (e.g., S-SSS, P-SSS, reference signal, and/or PSBCH) may be transmitted in the symbol #1. A variant BM-S-SSB, an extended BM-S-SSB, and/or a combined BM-S-SSB from the BM-S-SSB described above may be used.

In the exemplary embodiment(s), the position of BM RS may be configured differently for each transmitting terminal. For example, the position of a first BM RS of a first transmitting terminal may be configured differently from a position of a second BM RS of a second transmitting terminal. In this case, interference between the BM RSs may be minimized. Configuration information of BM RS may be included in the synchronization configuration information. The receiving terminal may identify the transmitting terminal that transmitted the BM-S-SSB by detecting the S-PSS and/or S-SSS included in the BM-S-SSB transmitted by the transmitting terminal. The receiving terminal may perform a reception operation (e.g., decoding operations) for the BM RS based on the configuration information of BM RS associated with the identified transmitting terminal. The receiving terminal may perform beam information measurement operations based on the BM RS and transmit measurement results of beam information (e.g., BSI) to the transmitting terminal. The transmitting terminal may maintain or change transmission beam(s) of the transmitting terminal based on the BSI.

The receiving terminal may receive the BM-S-SSB from the transmitting terminal based on the configuration information of BM-S-SSB and/or BM RS. By detecting the S-PSS and/or S-SSS included in the BM-S-SSB, the receiving terminal may identify the position of BM RS and perform a reception operation (e.g., decoding operations) for the BM RS at the identified position. For example, based on the detected S-PSS and/or detected S-SSS, an index of the sequence, a type of the sequence, and/or an SLSS ID may be identified, and the position of transmission resources for the BM RS may be indicated by the index of the sequence, the type of the sequence, and/or the SLSS ID. In this case, the receiving terminal may identify the position of the transmission resources for the BM RS based on the index of the sequence, the type of the sequence, and/or the SLSS ID and may perform a reception operation (e.g., decoding operations) for the BM RS at the identified position.

Transmitting terminals may use BM-S-SSBs with different structures. For example, a first transmitting terminal may transmit the BM-S-SSB shown in FIG. 12, a second transmitting terminal may transmit the BM-S-SSB shown in FIG. 13, and a third transmitting terminal may transmit the BM-S-SSB shown in FIG. 15. The BM RS may be used as a reference signal for beam information measurement through CSI-RS configuration. A new reference signal for beam information measurement may be defined.

The BM-S-SSB may be transmitted based on the scheme illustrated in FIG. 10. Configuration values for the transmission of synchronization signals (e.g., BM-S-SSB and/or Sync-S-SSB) may be preconfigured. Alternatively, the configuration values for the transmission of synchronization signals may be fixed values. The configuration values for the transmission of synchronization signals may include an S-SSB period, a periodicity of the S-SSB period, a time offset, a time interval, and/or the number of S-SSBs transmitted within a single S-SSB period. All or part of the configuration values for synchronization signal transmission may be configured to terminals through signaling (e.g., SI signaling, RRC signaling, MAC signaling, and/or PHY signaling).

Meanwhile, BM-S-SSB transmission may be performed consecutively over multiple slots. The multiple slots in which BM-S-SSB transmission is performed may be configured based on a specific periodicity. A synchronization slot may be a slot in which synchronization signals (e.g., BM-S-SSB and/or Sync-S-SSB) are transmitted.

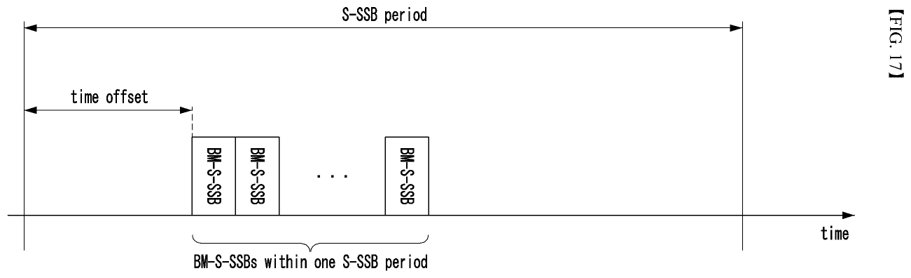

FIG. 17 is a conceptual diagram illustrating a first exemplary embodiment of a method for transmitting synchronization signals.

Referring to FIG. 17, consecutive BM-S-SSB transmissions may be performed within an S-SSB period. The consecutive BM-S-SSB transmissions may be performed in consecutive slots. Alternatively, consecutive BM-S-SSB transmissions may be performed in slots with an interval of n slots. n may be a natural number and may be included in the synchronization configuration information. Consecutive BM-S-SSB group transmissions may be performed within an S-SSB period. A BM-S-SSB group may include one or more BM-S-SSBs. The synchronization configuration information may include at least one of information on an S-SSB period (e.g., the length and/or periodicity of the S-SSB period), a time offset for the S-SSB period, a time interval for the S-SSB periods, the number of BM-S-SSBs that can be transmitted within the S-SSB period (e.g., consecutive BM-S-SSBs), an interval between slots in which the BM-S-SSBs are transmitted, the number of BM-S-SSB groups (e.g., consecutive BM-S-SSB groups) that can be transmitted within the S-SSB period, or the time interval of BM-S-SSB groups. All or part of the synchronization configuration information may be transmitted using at least one of SI signaling, RRC signaling, MAC signaling, or PHY signaling.

The BM-S-SSBs may be transmitted in an aperiodic manner or a semi-persistent manner. In this case, the transmitting terminal may transmit the BM-S-SSBs based on the aperiodic manner or the semi-persistent manner during a preconfigured period (e.g., predetermined period). If BM-S-SSB transmission is enabled by the base station, the transmitting terminal may transmit the BM-S-SSB. If BM-S-SSB transmission is disabled by the base station, the transmitting terminal may not transmit the BM-S-SSB. Alternatively, the BM-S-SSBs may be transmitted in a periodic manner. In this case, the transmitting terminal may periodically transmit the BM-S-SSB. When the BM-S-SSB is transmitted in an aperiodic manner or a semi-persistent manner, a transmission period (e.g., transmission range) of the BM-S-SSB may be configured or indicated to terminals based on at least one of SI signaling, RRC signaling, MAC signaling, or PHY signaling.

A beam pattern for transmitting synchronization signal (e.g., BM-S-SSB and/or Sync-S-SSB) may be defined. The beam pattern may be configured in units of n synchronization signals, n synchronization signal groups, or n S-SSB periods. n may be a natural number and may be configured to terminals through signaling. n may be included in the synchronization configuration information. Within a period corresponding to the configuration unit of the beam pattern, the transmitting terminal may transmit synchronization signals using all transmission beams based on the beam pattern. In this case, the synchronization signals may be transmitted using a beam sweeping scheme based on the beam pattern.

A single BM-S-SSB or a single BM-S-SSB group may be configured to be transmitted using a single transmission beam. In this case, within one BM-S-SSB or one BM-S-SSB group, the same transmission beam may be used for all transmission symbols of S-PSS, S-SSS, and BM RS used for beam information measurement.

Unlike the above-described method, a transmission operation using the same beam (e.g., the same transmission beam) may be configured to be performed in units of n symbols. n may be a natural number. If n is configured as 1, the transmitting terminal may perform BM-S-SSB transmission using a different beam for each symbol during the BM-S-SSB transmission procedure. For example, the transmitting terminal may use a transmission beam #1 to transmit S-an PSS in a symbol #m and may use a transmission beam #2 to transmit an S-SSS in a symbol #m+1.

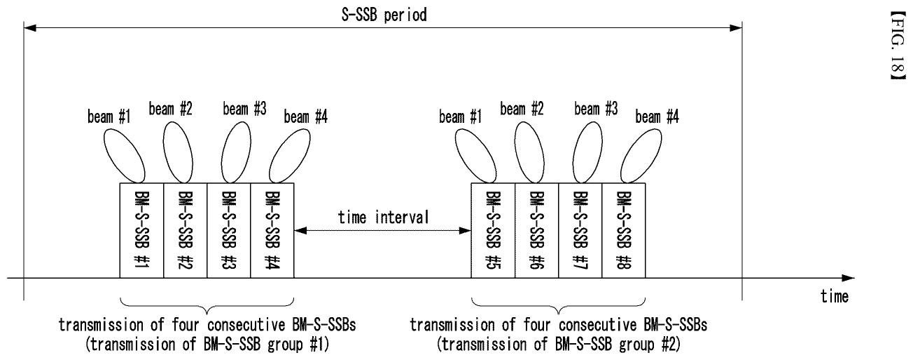

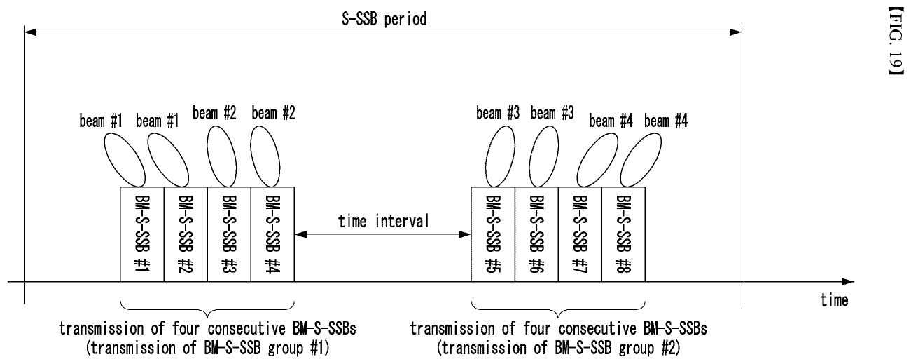

FIG. 18 is a conceptual diagram illustrating a second exemplary embodiment of a method for transmitting synchronization signals, and FIG. 19 is a conceptual diagram illustrating a third exemplary embodiment of a method for transmitting synchronization signals.

As shown in FIGS. 18 and 19, the transmitting terminal may transmit BM-S-SSBs within an S-SSB period. The transmitting terminal may transmit eight BM-S-SSBs within the S-SSB period. For example, the transmitting terminal may transmit four consecutive BM-S-SSBs (e.g., BM-S-SSB #1 to #4) and, after a time interval from a transmission time of the four consecutive BM-S-SSBs, may transmit another four consecutive BM-S-SSBs (e.g., BM-S-SSB #5 to #8). The BM-S-SSB #1 to #4 may constitute a BM-S-SSB group #1, and the BM-S-SSB #5 to #8 may constitute a BM-S-SSB group #2. The transmitting terminal may transmit the BM-S-SSBs based on a beam sweeping scheme. The transmitting terminal may use four beams (e.g., four transmission beams) to transmit the BM-S-SSBs. The four beams may include a beam #1, beam #2, beam #3, and beam #4. The maximum number of beams supportable by the transmitting terminal may be 4.

The transmitting terminal may transmit one BM-S-SSB using one beam. In the exemplary embodiments of FIGS. 18 and 19, the beam pattern may follow a sequence of ‘beam #1-beam #2-beam #3-beam #4’. The beam pattern information may be configured or indicated to terminals through signaling. In the exemplary embodiment of FIG. 18, a different beam may be used for each BM-S-SSB transmission. For example, the transmitting terminal may transmit the BM-S-SSB #1 using the beam #1, the BM-S-SSB #2 using the beam #2, the BM-S-SSB #3 using the beam #3, the BM-S-SSB #4 using the beam #4, the BM-S-SSB #5 using the beam #1, the BM-S-SSB #6 using the beam #2, the BM-S-SSB #7 using the beam #3, and the BM-S-SSB #8 using th beam #4.

In the exemplary embodiment of FIG. 19, a different beam may be used for every 2 BM-S-SSB transmissions. For example, the transmitting terminal may transmit the BM-S-SSBs #1 and #2 using the beam #1, the BM-S-SSBs #3 and #4 using the beam #2, the BM-S-SSBs #5 and #6 using the beam #3, and the BM-S-SSBs #7 and #8 using the beam #4.

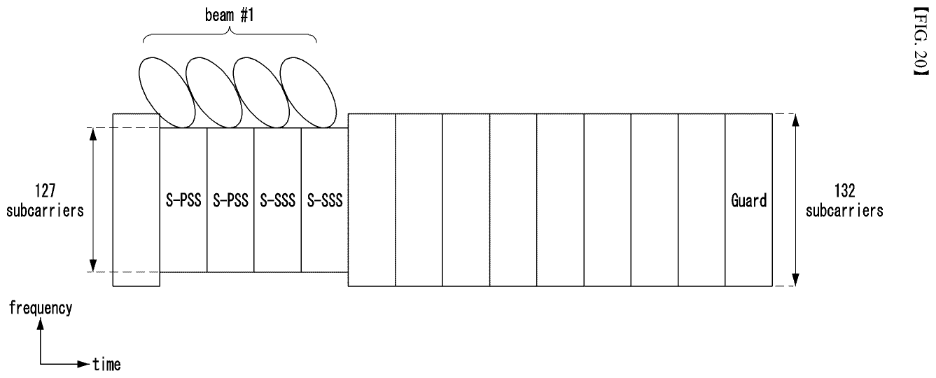

FIG. 20 is a conceptual diagram illustrating a fourth exemplary embodiment of a method for transmitting synchronization signals.

As shown in FIG. 20, the transmitting terminal may transmit the BM-S-SSB with the structure shown in FIG. 12 based on the method illustrated in FIG. 18 or FIG. 19. Since one beam is used for a single BM-S-SSB transmission, the transmitting terminal may transmit the S-PSSs and S-SSSs belonging to one BM-S-SSB using a single beam (e.g., beam #1).

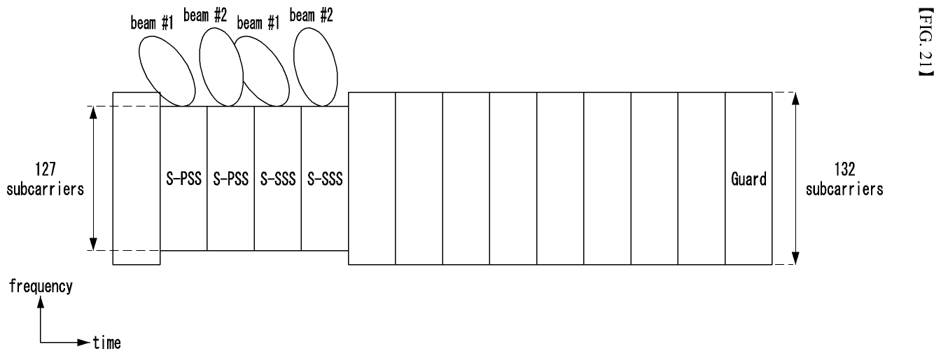

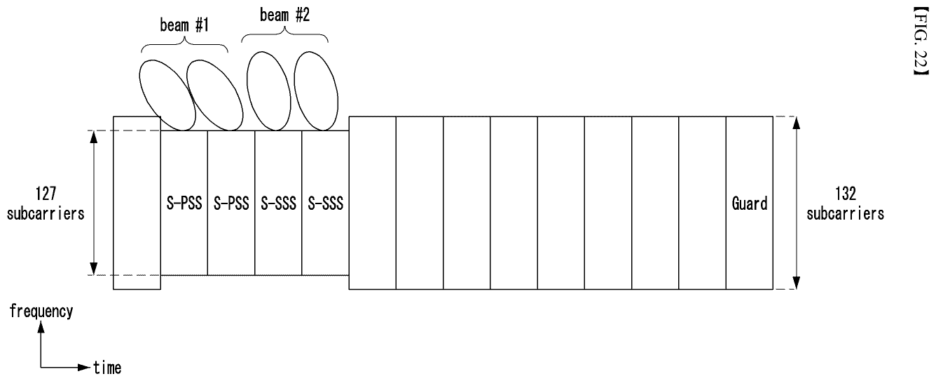

In the BM-S-SSB transmission procedure, a different beam may be configured to be used for every two symbols (e.g., two consecutive symbols or two non-consecutive symbols). In this case, the transmitting terminal may transmit the BM-S-SSB based on the method illustrated in FIG. 21 or the method illustrated in FIG. 22.

FIG. 21 is a conceptual diagram illustrating a fifth exemplary embodiment of a method for transmitting synchronization signals.

As shown in FIG. 21, the transmitting terminal may transmit the BM-S-SSB with the structure shown in FIG. 12. For example, the transmitting terminal may transmit the first S-PSS of the BM-S-SSB using th beam #1, transmit the second S-PSS of the BM-S-SSB using the beam #2, transmit the first S-SSS of the BM-S-SSB using the beam #1, and transmit the second S-SSS of the BM-S-SSB using the beam #2.

FIG. 22 is a conceptual diagram illustrating a sixth exemplary embodiment of a method for transmitting synchronization signals.

Referring to FIG. 22, the transmitting terminal may transmit the BM-S-SSB with the structure shown in FIG. 12. For example, the transmitting terminal may transmit the first and second S-PSSs of the BM-S-SSB using the beam #1 and may transmit the first and second S-SSSs of the BM-S-SSB using the beam #2.

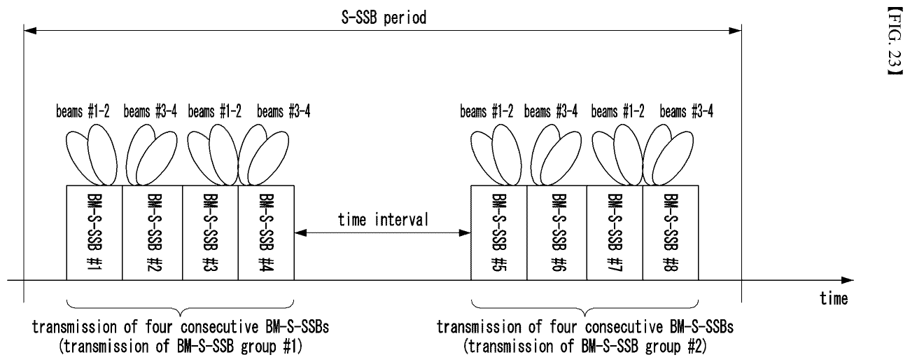

The BM-S-SSB transmission based on the method illustrated in FIG. 21 or FIG. 22 may be performed as shown in the exemplary embodiment of FIG. 23.

FIG. 23 is a conceptual diagram illustrating a seventh exemplary embodiment of a method for transmitting synchronization signals.

As shown in FIG. 23, the transmitting terminal may transmit one BM-S-SSB using two beams. For example, the transmitting terminal may transmit the BM-S-SSB #1 using the beams #1 and #2, transmit the BM-S-SSB #2 using the beams #3 and #4, transmit the BM-S-SSB #3 using the beams #1 and #2, transmit the BM-S-SSB #4 using the beams #3 and #4, transmit the BM-S-SSB #5 using the beams #1 and #2, transmit the BM-S-SSB #6 using the beams #3 and #4, transmit the BM-S-SSB #7 using the beams #1 and #2, and transmit the BM-S-SSB #8 using the beams #3 and #4. In this case, a beam sweeping operation covering all beams of the transmitting terminal (e.g., four beams) may be achieved by two BM-S-SSB transmissions.

In the example of FIG. 23, the beam pattern of the transmitting terminal (e.g., beam sweeping pattern) may be defined in units of two BM-S-SSB transmissions. Alternatively, the beam pattern of the transmitting terminal (e.g., beam sweeping pattern) may be defined in units of four BM-S-SSB transmissions. In other words, the beam pattern of the transmitting terminal may be defined in units of n BM-S-SSB transmissions. n may be a natural number and may be included in the synchronization configuration information.

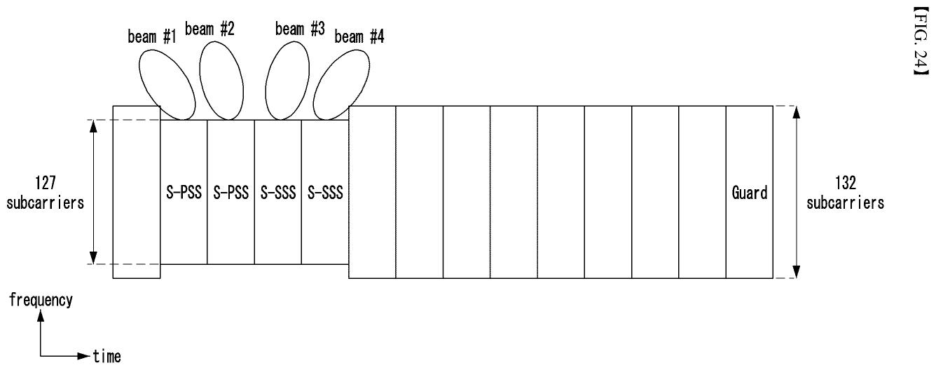

FIG. 24 is a conceptual diagram illustrating an eighth exemplary embodiment of a method for transmitting synchronization signals.

As shown in FIG. 24, the transmitting terminal may perform BM-S-SSB transmission using a different beam for each symbol. For example, the transmitting terminal may use the beam #1 to transmit the first S-PSS of the BM-S-SSB, use the beam #2 to transmit the second S-PSS of the BM-S-SSB, use the beam #3 to transmit the first S-SSS of the BM-S-SSB, and use the beam #4 to transmit the second S-SSS of the BM-S-SSB. When the beam sweeping operation (e.g., beam pattern) is configured, the transmitting terminal may sweep all beams during the transmission procedure of a single BM-S-SSB.

In the present disclosure, synchronization signals (e.g., BM-S-SSB and/or Sync-S-SSB) may have various structures, and resources for transmitting synchronization signals may be configured in various manners. The transmitting terminal (e.g., a synchronization terminal or a synchronization reference terminal) may operate the BM-S-SSB and Sync-S-SSB independently. The BM-S-SSB and Sync-S-SSB may be independently configured.

To prevent collisions between BM-S-SSB and Sync-S-SSB, BM-S-SSB and Sync-S-SSB may be independently configured. BM-S-SSB transmission may be performed based on the configuration information of BM-S-SSB, and Sync-S-SSB transmission may be performed based on the configuration information of Sync-S-SSB. The configuration information of BM-S-SSB and Sync-S-SSB may be configured to terminals through signaling.

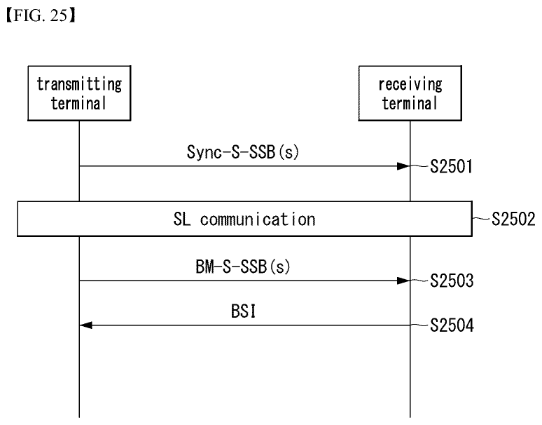

FIG. 25 is a sequence chart illustrating a first exemplary embodiment of a beam management method.

As shown in FIG. 25, an exemplary embodiment of a beam management method involving independent operations of Sync-S-SSB and BM-S-SSB may be illustrated for a case where the transmitting terminal serves as a synchronization terminal (e.g., Sync-UE) for the receiving terminal. The synchronization terminal may refer to a terminal that transmits S-SSBs, which the receiving terminal receives for initial synchronization. A base station may generate synchronization configuration information and transmit the synchronization configuration information to terminals (e.g., the transmitting terminal and/or the receiving terminal) through signaling. The terminals may receive the synchronization configuration information from the base station. The synchronization configuration information may include configuration information for Sync-S-SSB and/or BM-S-SSB. Sync-S-SSB and BM-S-SSB may be independently configured. Alternatively, the transmitting terminal may generate the synchronization configuration information and transmit it to the receiving terminal(s) through signaling. The receiving terminal(s) may receive the synchronization configuration information from the transmitting terminal.

The transmitting terminal may transmit Sync-S-SSB(s) to the receiving terminal(s) based on the synchronization configuration information (S2501). The Sync-S-SSB(s) may be used for synchronization between the transmitting terminal and the receiving terminal. The Sync-S-SSB(s) may have the structure illustrated in FIG. 9. The receiving terminal may receive Sync-S-SSB(s) from the transmitting terminal based on the synchronization configuration information and obtain synchronization information of the transmitting terminal based on the Sync-S-SSB(s). The receiving terminal may synchronize with the transmitting terminal based on the synchronization information. Thereafter, SL communication between the transmitting terminal and the receiving terminal may be performed (S2502). The SL communication may be performed using beams. For example, a beam pair between the transmitting terminal's transmission beam and the receiving terminal's reception beam may be configured, and the SL communication may be performed using the beam pair (e.g., transmission beam-reception beam).

In SL communication, beam management operations (e.g., beam measurement operations) may be required. When beam management operations are required, the transmitting terminal may transmit BM-S-SSB(s) to the receiving terminal based on the synchronization configuration information (S2503). Alternatively, regardless of the necessity of beam management operations, the transmitting terminal may transmit BM-S-SSB(s) to the receiving terminal. If BM-S-SSB transmission is enabled or activated by the base station (e.g., when information indicating the enablement or activation of BM-S-SSB transmission is received from the base station), the transmitting terminal may transmit BM-S-SSB(s) to the receiving terminal. The BM-S-SSB(s) may have the structure shown in FIG. 12, FIG. 13, FIG. 14, FIG. 15, or FIG. 16. The BM-S-SSB transmission may be performed based on the methods illustrated in FIG. 17, FIG. 18, FIG. 19, FIG. 20, FIG. 21, FIG. 22, FIG. 23, and/or FIG. 24. The BM-S-SSB(s) may be used for beam management operations between the transmitting terminal and the receiving terminal.

The receiving terminal may receive BM-S-SSB(s) from the transmitting terminal based on the synchronization configuration information and measure beam information based on the BM-S-SSB(s). The receiving terminal may transmit measurement results of the beam information (e.g., beam state information (BSI)) to the transmitting terminal (S2504). The BSI may include an index of a beam with the best quality among the transmitting terminal's beams (e.g., transmission beams) and/or quality information of the transmitting terminal's beam(s). The transmitting terminal may receive the BSI from the receiving terminal and maintain or change transmission beam(s) based on the information elements included in the BSI.

The transmitting terminal may receive information from the base station indicating disablement or deactivation of BM-S-SSB transmission. In this case, the transmitting terminal may stop BM-S-SSB transmission. When BM-S-SSB transmission is disabled or deactivated, beam management operations may be stopped.

In step S2502, before transmitting BM-S-SSB(s), the transmitting terminal may transmit a request message for BSI to the receiving terminal. The transmitting terminal may transmit BM-S-SSB(s) after transmitting the request message for BSI. In this case, the request message for BSI may include all or part of the configuration information related to BM-S-SSB transmission and/or configuration information regarding BSI to be reported by the receiving terminal.

Although the exemplary embodiment in FIG. 25 pertains to the case where the transmitting terminal is the synchronization terminal, if the initial synchronization of the receiving terminal is acquired based on another synchronization source (e.g., base station, satellite, etc.), the receiving terminal may perform the operations described above (e.g., steps S2503 to S2504) without performing the step of receiving Sync-S-SSB(s) from the transmitting terminal (S2501).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
transmitting one or more beam management (BM)-sidelink (S)-synchronization signal blocks (SSBs) to a second UE; and
receiving beam state information (BSI) measured based on the one or more BM-S-SSBs from the second UE,
wherein each of the one or more BM-S-SSBs includes a sidelink-primary synchronization signal (S-PSS) and a sidelink-secondary synchronization signal (S-SSS) without a physical sidelink broadcast channel (PSBCH).

2. The method according to claim 1, further comprising: transmitting one or more Sync-S-SSBs to the second UE before transmitting the one or more BM-S-SSBs,
wherein the one or more Sync-S-SSBs are used for synchronization between the first UE and the second UE, and each of the one or more Sync-S-SSBs includes an S-PSS, S-SSS, and PSBCH.

3. The method according to claim 1, wherein each of the one or more BM-S-SSBs further includes a BM reference signal (RS), and the BM RS is mapped to a transmission resource of the PSBCH in time domain.

4. The method according to claim 3, wherein the BM RS is mapped to one or more subcarriers that do not overlap with a PSBCH demodulation reference signal (DMRS) included in a Sync-S-SSB transmitted by the first UE in frequency domain.

5. The method according to claim 4, wherein the one or more subcarriers to which the BM RS is mapped in frequency domain are determined based on an offset with respect to subcarriers to which the PSBCH DMRS is mapped.

6. The method according to claim 1, wherein the BM-S-SSB further includes at least one of one or more additional S-PSSs or one or more additional S-SSSs, and the at least one of the one or more additional S-PSSs or the one or more additional S-SSSs is mapped to a transmission resource of the PSBCH in time domain.

7. The method according to claim 2, further comprising: receiving synchronization configuration information including first configuration information of Sync-S-SSB and second configuration information of BM-S-SSB from a base station,
wherein the one or more Sync-S-SSBs are transmitted based on the first configuration information, and the one or more BM-S-SSBs are transmitted based on the second configuration information.

8. The method according to claim 2, wherein the one or more Sync-S-SSBs and the one or more BM-S-SSBs are independently configured, and transmission resources of the one or more Sync-S-SSBs are different from transmission resources of the one or more BM-S-SSBs.

9. The method according to claim 1, further comprising: maintaining or changing beam(s) used in SL communication between the first UE and the second UE based on the BSI.

10. The method according to claim 1, wherein the one or more BM-S-SSBs are transmitted based on a beam sweeping scheme according to a beam pattern, and the one or more BM-S-SSBs are transmitted through different beams in units of n BM-S-SSBs, n being a natural number.

11. A method of a second user equipment (UE), comprising:
receiving one or more beam management (BM)-sidelink (S)-synchronization signal block (SSBs) from a first UE;
measuring beam information for the first UE based on the one or more BM-S-SSBs; and
transmitting beam state information (BSI) including the beam information to the first UE,
wherein each of the one or more BM-S-SSBs includes a sidelink-primary synchronization signal (S-PSS) and a sidelink-secondary synchronization signal (S-SSS) without a physical sidelink broadcast channel (PSBCH).

12. The method according to claim 11, further comprising: before receiving the one or more BM-S-SSBs,
receiving one or more Sync-S-SSBs from the first UE; and
obtaining synchronization information of the first UE based on the one or more Sync-S-SSBs,
wherein each of the one or more Sync-S-SSBs includes an S-PSS, S-SSS, and PSBCH.

13. The method according to claim 11, wherein each of the one or more BM-S-SSBs further includes a BM reference signal (RS), and the BM RS is mapped to a transmission resource of the PSBCH in time domain.

14. The method according to claim 13, wherein the BM RS is mapped to one or more subcarriers that do not overlap with a PSBCH demodulation reference signal (DMRS) included in a Sync-S-SSB received from the first UE in frequency domain.

15. The method according to claim 11, wherein the BM-S-SSB further includes at least one of one or more additional S-PSSs or one or more additional S-SSSs, and the at least one of the one or more additional S-PSSs or the one or more additional S-SSSs is mapped to a transmission resource of the PSBCH in time domain.

16. A first user equipment (UE) comprising at least one processor, wherein the at least one processor causes the first UE to perform:
transmitting one or more beam management (BM)-sidelink (S)-synchronization signal blocks (SSBs) to a second UE; and
receiving beam state information (BSI) measured based on the one or more BM-S-SSBs from the second UE,
wherein each of the one or more BM-S-SSBs includes a sidelink-primary synchronization signal (S-PSS) and a sidelink-secondary synchronization signal (S-SSS) without a physical sidelink broadcast channel (PSBCH).

17. The first UE according to claim 16, wherein the at least one processor further causes the first UE to perform: transmitting one or more Sync-S-SSBs to the second UE before transmitting the one or more BM-S-SSBs,
wherein the one or more Sync-S-SSBs are used for synchronization between the first UE and the second UE, and each of the one or more Sync-S-SSBs includes an S-PSS, S-SSS, and PSBCH.

18. The first UE according to claim 16, wherein each of the one or more BM-S-SSBs further includes a BM reference signal (RS), and the BM RS is mapped to a transmission resource of the PSBCH in time domain.

19. The first UE according to claim 18, wherein the BM RS is mapped to one or more subcarriers that do not overlap with a PSBCH demodulation reference signal (DMRS) included in a Sync-S-SSB transmitted by the first UE in frequency domain.

20. The first UE according to claim 16, wherein the BM-S-SSB further includes at least one of one or more additional S-PSSs or one or more additional S-SSSs, and the at least one of the one or more additional S-PSSs or the one or more additional S-SSSs is mapped to a transmission resource of the PSBCH in time domain.
